(19) United States
(12) Patent Application Publication
(10) Pub. No.: US 2011/0256502 A1
(43) Pub. Date: Oct. 20, 2011

(54) DENTAL FULCRUM WRENCH

(76) Inventor: Howard Ian Katz, La Jolla, CA (US)

(21) Appl. No.: 12/875,910

(22) Filed: Sep. 3, 2010

Related U.S. Application Data
(60) Provisional application No. 61/325,514, filed on Apr. 19, 2010.

(51) Int. Cl. A61C 3/14

(52) U.S. Cl. 433/114; 433/153; 433/215

(57) ABSTRACT

A dental wrench device to loosen and extract teeth, comprising a handle with a fixed tapered jaw. A moveable jaw is also coupled to the handle. The tapered jaw is positioned along the root of a tooth selected to be extracted. The moveable jaw has a blunt contoured shape configured to grasp the gum and bone on the opposite side of the selected tooth at a level below the crown of the tooth. The device is applied and tightened around the selected tooth by turning a thumbscrew, or other jaw movement interface, that moves the moveable jaw end closer to the fixed tapered jaw end until the tooth is tightly gripped by the device. Once the wrench is locked into position, force may then be applied to extract the tooth. The device may also incorporate an optional force feedback gauge to warn the operator when excessive force is being applied.

### CROSS REFERENCE TO RELATED APPLICATIONS

This application claims the priority benefit of U.S. Provisional Application No. 61/325,514, filed on Apr. 19, 2010, entitled “A wrench to loosen and extract teeth”, Howard Katz inventor.

### BACKGROUND OF THE INVENTION

1. Field of the Invention

The invention is in the general field of dental and surgical tools.

2. Description of the Related Art

Traditionally, tooth extraction has been an arduous process in which the first and second jaws of dental pliers or forceps are used to grasp onto opposite sides of a tooth above the gum line. The dentist will then both wiggle the tooth, and apply sufficient withdrawing force to pull the tooth out of the socket. This process has the drawbacks of requiring that the dentist have a significant amount of physical hand strength, and the process also creates a relatively high risk of inadvertent bone fracture due to the high amount of force required to extract the tooth.

A number of different types tooth extracting tools are presently in common use. These tools include multiple types of pliers/forceps tools and multiple types of elevator tools, each designed for a particular application or tooth surface. Forceps, in combination with the dentist's hand strength, distort the bone around the roots of the tooth so that the tooth separates, loosens and comes out. Here the dentist must determine the proper amount of force—enough to loosen the teeth, not enough to fracture the bone, based on only on experience and the dentist's natural motor skills and senses.

In order to loosen teeth properly, sometimes the teeth need to be tilted in a direction towards that of the neighboring teeth. Here elevator tools may be used for this purpose, but these tools may have the drawback of inadvertently causing damage to these neighboring teeth.

Prior art in these types of dental tools includes Burch, U.S. Pat. No. 8,351, Hughes U.S. Pat. No. 354,863, Joesch U.S. Pat. No. 628,499, and Hamilton 6,280,184.

Golden, U.S. Pat. No. 6,910,890 describes a dental pliers appliance and method for removing teeth from a patient's gum line and bone. This method comprises using a specialized type of dental pliers in which one portion of the pliers rests on a section of the patient's jaw. This type of tool is presently marketed under the tradename Physics Forcepts® by GoldenMisch Inc., Detroit Mich.

Other dental forceps devices have been described by Kahn-Shullman U.S. patent application 2004/0152044, and Roberts U.S. patent application 2008/0044792.

### BRIEF SUMMARY OF THE INVENTION

In one embodiment, the invention may be a dental wrench device to loosen and extract teeth. This device may, for example, comprise a handle shaped to fit inside the dentist's hand, usually when the hand is in a clenched configuration. One end of this handle may terminate in a fixed tapered jaw end that has a sharpened edge, or sharpened and contoured edge, with dimensions configured so as to enable this fixed tapered jaw end to be positioned along the tooth root or roots of a tooth selected for extraction below the gum line of this tooth, often on the inside of the mouth. In addition to the fixed tapered jaw end, a moveable jaw end will also be coupled to this handle. This moveable jaw end will typically have a blunt and often cushioned surface with a shape configured to conform to and grasp the gum and bone proximate to the selected tooth and that support this selected tooth and in which the tooth roots of the selected tooth are embedded. The shape of the moveable jaw end will typically grasp this gum and bone at a level below the crown of the selected tooth, and typically on the side of the tooth opposite to the side where the fixed tapered jaw end is positioned. The wrench may then be tightened around the selected tooth by turning a thumbscrew (which will often either be a worm gear or connected to a worm gear, or other jaw movement interface), that will move the moveable jaw end closer to the fixed tapered jaw end until the tooth is tightly gripped by the device. This thumbscrew will often be mounted in a hole in the device handle.

The device handle and angles and offsets of the device's jaws will be configured so as to allow various versions of the device to be fit into the mouth of an adult or pediatric patient, be manipulated by a dentist working outside of the mouth, and be used to extract various types of teeth—such as upper and lower, left side and right side molars, premolars, canine teeth, incisors. Thus there may be left handed, right handed, or symmetric versions of the device, as well as adult and pediatric device sizes. The device will be further configured so that application of force to the device's handle will cause device to act as a fulcrum, applying force to the selected tooth, which in turn can be used to dislodge the selected tooth from the supporting gum and bone in which the tooth roots of the selected tooth are embedded.

In some embodiments, the invention will also have force measuring devices or gauges attached which will assist the dentist in determining the optimum amount of force or pressure to apply to the device—that is, an amount of force or pressure adequate to loosen the selected tooth without breaking the bone in which the tooth is embedded.

In an alternative embodiment, the invention may be a method for loosening and extracting teeth, using a dental wrench device such as the device described above. Here the method will generally comprise applying a dental wrench device to a tooth selected for extraction, and placing one fixed tapered jaw with a sharpened edge along the tooth roots of the selected tooth below the gum line, placing the other moveable jaw end with a blunt end (contoured to provide optimal contact with the gum, and thus either convex for gum on the tongue side of the tooth, or concave for the gum on the lip side of the tooth) on the opposite side of the selected tooth so as to grasp the gum and bone proximate the tooth roots of the selected tooth and in which these tooth roots are embedded. The jaws will then be tightened relative to each other, usually by turning a thumbscrew or activating other jaw movement interface on the device that moves the moveable jaw end relative to the fixed jaw end so as to tightly grasp this supporting gum and bone. Force is then applied to the handle in a direction so as to cause the jaw of the device supporting the gum and bone to act as a fulcrum which in turn applies force to the selected tooth to dislodge this tooth from the supporting gum and bone.

Alternatively, the moveable jaw having a complex surface forms a large center point of rotation or fulcrum for the lever created by the handle of the device, so that application of force to the handle causes a combined inwardly and upwardly actuated rotation of the handle, causing the tooth to pivot towards the fulcrum and forcibly dislodge from the gum line and bone.

The selected tooth may then be extracted. This can be done by either directly using the device, or alternatively the removing the device, and extracting the now loosened tooth using another tool or by hand.

Thus among the various advantages of the invention disclosed herein versus prior art dental forceps devices is the advantage of the elimination of the need for the user to squeeze the device tightly using his or her hands. Such squeezing is undesirable, because there is less control when the user has to squeeze, and at the same time the squeezing action by the wrist tends to force prior art forceps in a downward direction even when this direction is not desired. Further, the elimination of the multiple divergent handles of the prior art forceps design makes the invention easier to operate by weaker and smaller dentists. That is, much less force is necessary when using the invention.

The thumbscrew allows the user to adjust the tightness of the invention while simultaneously holding the handle with the same hand. This configuration has advantages over alternative wrench designs that may have the tightening apparatus at the back of the wrench, thus requiring two hands to operate optimally.

Further, as will be discussed, the invention may additionally have or comprise an optional back cap or other mechanism containing force measurement devices that can act as “trainer wheels” to give inexperienced users (or for that matter all users) information and warnings when excessive force is being used. Once the user learns how much force to use, this force-feedback back cap or other sensor mechanism or gauge can then be removed if this is desired.

### BRIEF DESCRIPTION OF THE DRAWINGS

FIG. 1 shows the device being used to extract a tooth.

FIG. 2 shows a front view of the left handed version of the device.

FIG. 3 shows a close-up of the device's fixed tapered jaw with a sharpened edge and moveable jaw with a convex surface configured to grasp supporting gum and bone.

FIG. 4 shows a back view of the left handed version of the device, showing the optional back cap and deformable lever that may be used to determine the proper amount of force to apply to the device.

FIG. 5 shows a back view of a right handed version of the device.

FIG. 6 shows a reverse version of the device used for applying force to loosen a tooth inwardly and upwardly into the mouth. Here the thumbscrew is not shown.

FIG. 7 shows a detail of the thumbscrew-worm gear arrangement which may be used to move the invention's moveable jaw.

FIG. 8 shows a front view of the device handle showing the fixed tapered jaw with a sharpened edge. Here the thumbscrew, the moveable jaw, and the optional back cap are not shown.

FIG. 9 shows a detail of the optional back cap and deformable lever, which may be attached to the back of the device and used to assess the proper amount of force to apply.

FIG. 10 shows a side view of the device showing the fixed tapered jaw with a sharpened edge towards the inside of the device and moveable jaw towards the end of the device, but with the thumbscrew not shown. This reverse version of the device may be used for applying force to loosen a tooth inwardly and upwardly into the mouth. In this configuration, the back cap and deformable lever also contain a force sensor—here an electronic force sensor that may, for example, light up a light emitting diode (LED) when excess force is being applied.

### DETAILED DESCRIPTION OF THE INVENTION

The device works by first positioning a fixed terminating sharpened end of a crescent wrench-like appliance along the tooth root surface of a selected tooth below the gum line. Then a second movable jaw of the device is positioned against the opposing facing side of the same tooth projecting from the gum line, and tightened about the tooth using a thumbscrew or other jaw movement interface device. When in position, the device functions as a single handled lever, and acts as a fulcrum forcing the tooth away from the patient's gum line. This forcibly dislodges the tooth from the patient's gum line and bone, in the direction of the applied force.

The forces engaged are similar to the effects of a dental elevator. In a dental elevator, the tooth is pried loose by using the smooth rounded surface of the back of the blade of the dental elevator as a fulcrum against the bone supporting the tooth to be extracted.

Where not otherwise specified, the device will often be constructed with polished rounded surfaces in order to do minimal trauma to the supporting gum and bone when levering forces are applied to the gum and bone.

Often the device may be constructed out of a suitable surgical tool metal, such as 410 stainless steel and the like; however other materials may also be used.

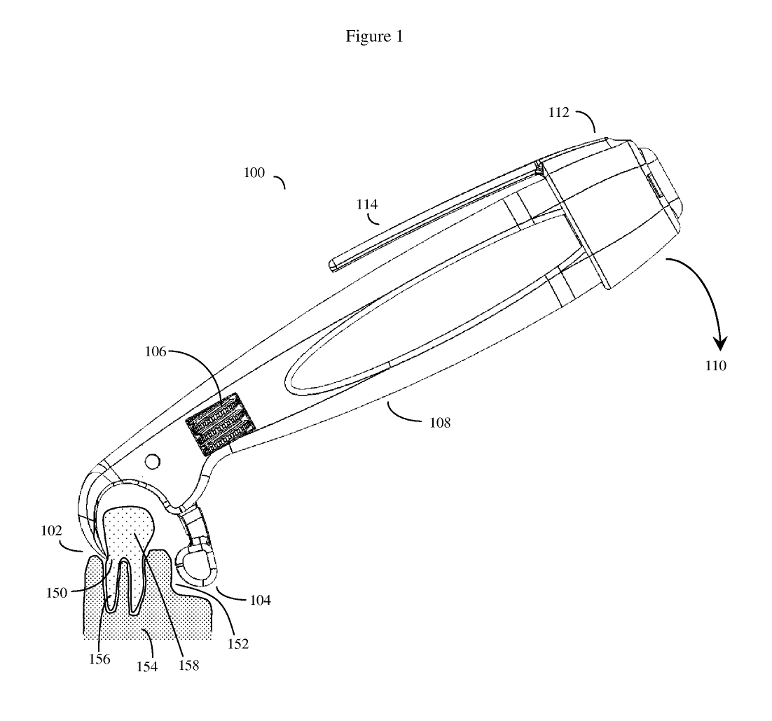

A diagram of one embodiment of the device (100) in action is shown in FIG. 1.

In use, the fixed sharpened jaw portion of the device (102) is positioned to abut against an inwardly facing side of a selected tooth (150), whereas the larger sized concave surface of the moveable or adjustable jaw (104) is positioned to grab and align along the patient's gum and just below the gum line (152). The device is configured so that the larger moveable jaw with the concave surface (104) moved by thumbscrew or worm gear or other jaw movement interface (106) supports and grabs the gum and bone (152) on the opposite side of the selected tooth (150). This forms a large center point of rotation or fulcrum for the lever created by the handle of the wrench device (108). The dentist will then apply force to the handle (108) in a combined outwardly and downwardly rotation like motion (110), causing of the tooth to pivot towards the fulcrum and forcibly dislodge from the gum line and bone.

The device of FIG. 1 is also equipped with an optional back cap (112) with a deformable lever (114) which will be discussed in more detail later.

The patient's bone (154), tooth roots (156) and tooth crown (158) are also shown.

Relative to other prior art devices, such as the device of Golden, U.S. Pat. No. 6,910,890; the invention disclosed herein has a number of advantages.

As previously discussed, the invention, being a single handled wrench, will generally be easier than the prior art two-handled forceps to handle. Additionally, using the invention, only a minimal grip force will be needed to extract the tooth, because the wrench device uses the thumbscrew mechanism (106) or other jaw movement interface to clamp the jaw ends (102) (104) to the tooth. By contrast, a high amount of hand force is required with prior art forceps devices. As a result, using the invention, any size tooth can be easily engaged even if the dentist's hands are relatively weak, and the invention's thumbscrew configuration (106) or other jaw movement interface avoids hand fatigue, which is often a problem for prior art forceps devices.

An additional benefit of the invention is that it can be configured to have a force gauge, such as a deformable lever (114) or removable calibrated spring gauge, which will assist the dentist in applying the apply ideal force necessary to loosen teeth without fracturing bone. By contrast, prior art forceps device lack such force gauges, and thus require the dentist to essentially guess what the correct force is. This deformable lever can be made from the same deformable material used to construct the back cap. Alternatively, the deformable lever may be made from a rigid material and instead attached to the back cap by way of a deformable spring or spring loaded axle.

Additionally, other features of the invention also offer advantages over prior art devices. The device may have a sharpened fixed jaw (102) which can be used to separate gingival and PDL tissue from the tooth in order to assist in extraction. By contrast, prior art forceps generally have blunt jaws which cannot engage the tooth under the gum. Additionally, the tapered jaw tip can be configured to fit both narrow and broad teeth. By contrast, prior art forceps devices generally have jaws that are too broad for the smallest teeth.

Although the fixed jaw (102) will often have a sharpened edge, such a sharpened edge is optional, and in some embodiments, fixed jaw (102) will not have a sharpened edge.

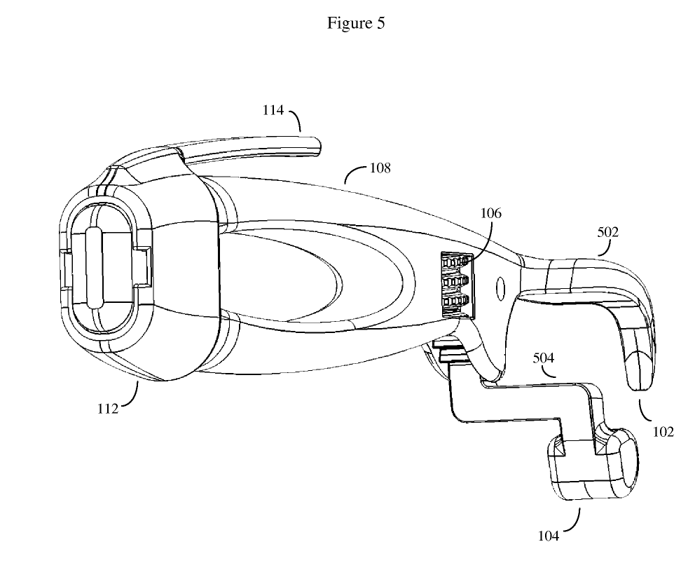

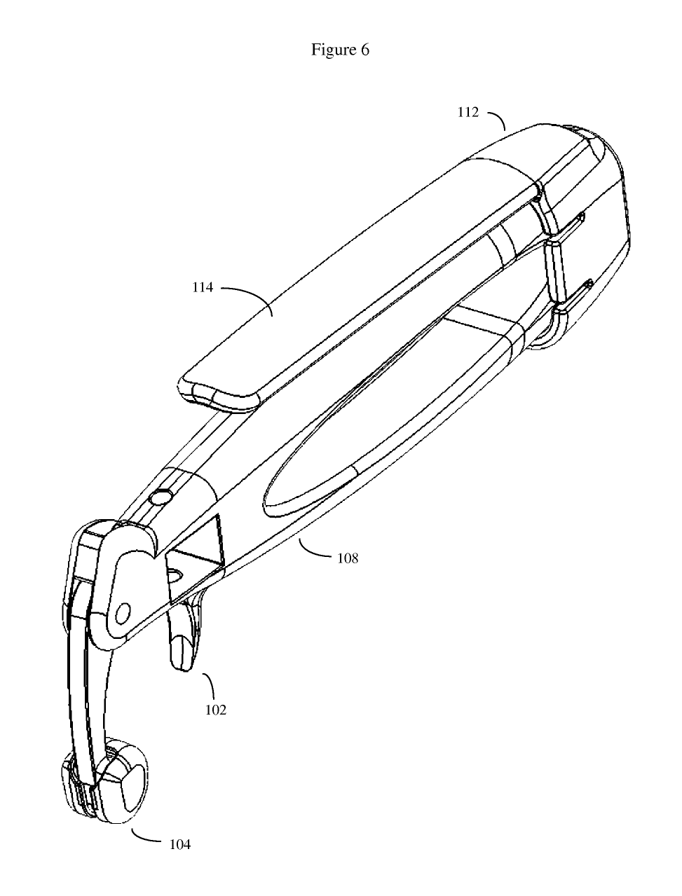

As will be discussed, multiple versions of the device, such as left handed versions (FIGS. 1, 2, 3, 4), right handed versions (FIG. 5), symmetric versions (FIG. 6), adult and pediatric versions may be produced. However the invention may be configured to be relatively versatile so that a single version may be used on both upper and lower teeth by configuring the angle of the device's head appropriately. By contrast, different prior art forceps devices are often needed for upper and lower teeth, as well as maxillary and molar teeth.

The end of the device (104) may be contoured to optimally contact the gum next to the tooth being extracted, and may optionally also be configured with an integral or additional bumper to engage the appropriate amount of gum surface needed to avoid trauma to the gum during the tooth extraction procedure. The end of the device (104) is contoured to provide optimal contact with the gum, and thus generally either convex for gum on the tongue side of the tooth, or concave for the gum on the lip side of the tooth, and is often configured to engage the gingival tissue only on the tooth that is being extracted, which is generally the best location for this procedure. Only engaging the gingival tissue on the tooth that is being extracted has an advantage over alternative designs (occasionally used in prior art forceps) that may use contoured ends that are broader than the tooth being extracted. The drawback of using such broader ends is that these ends are not always able to optimally support or contact the gum adjacent to the tooth selected for extraction, because the larger width makes it more difficult to conform to the gum surface which will often have a varying contour.

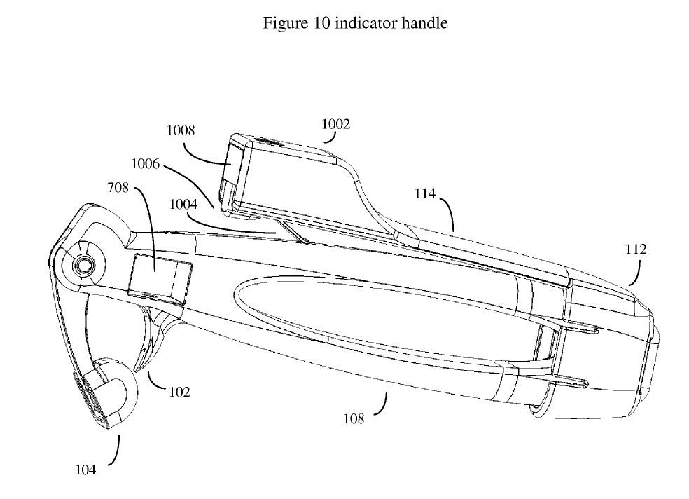

Generally the end of the device (104) or bumper will have a contoured concave shape, but on the reverse direction devices (e.g. FIG. 10), this end or bumper may alternatively have a convex shape to better conform to the shape of the gum tissue when used in the reverse direction. As previously discussed, this shape is generally contoured to provide optimal contact with the gum, so it may be convex for the gum inside (tongue side) of the tooth, and concave for the gum outside (lip side) of the tooth

The device's jaws may often be designed with a “zig-zag” or “dog leg” bent configuration both in the fixed and adjustable jaws. This “dog leg” (202), (204), (502), (504) bent configuration can help prevent trauma to the lips when the wrench is positioned for the extraction of molar teeth. Thus by placing the dog-leg in the fixed and movable jaws, the thumbscrew (106) or other jaw movement interface can be placed in the handle (108) in an ergonomic position which allows the dentist to easily access the thumbscrew because it will be positioned outside of the mouth of the patient. By contrast, if the “dog leg” was positioned in the handle (108), the thumbscrew might have to be positioned inside the patient's mouth, making it awkward to move the adjustable thumbscrew. The “dog leg” can be right handed (502), (504) or left handed (202), (204).

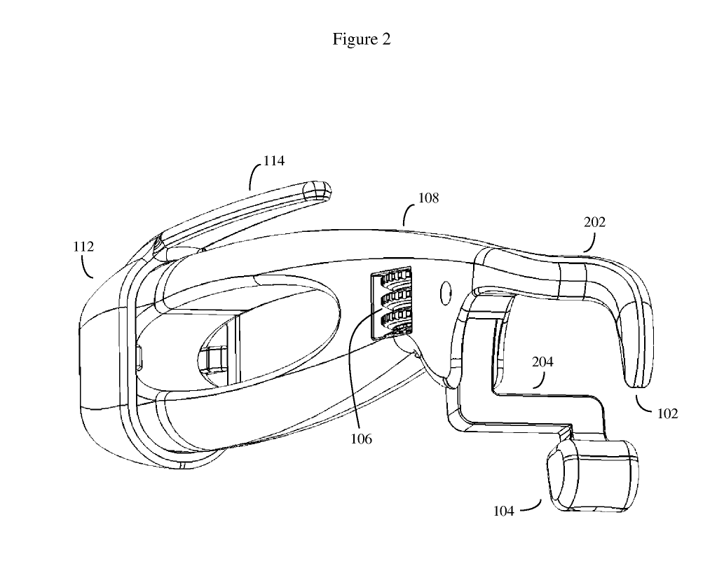

FIG. 2 shows a front view of the left handed version of the device. Here the left handed dog leg for the upper fixed jaw (102) is shown as (202), while the left handed dog leg for the lower moveable jaw is shown as (204).

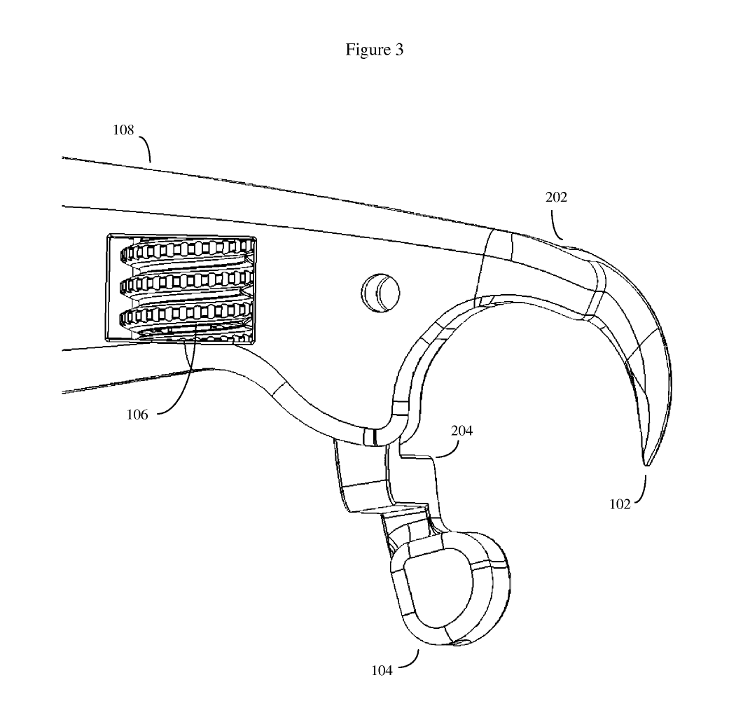

FIG. 3 shows a close-up of the device's fixed tapered jaw with a sharpened edge 102) and moveable jaw with a convex surface (104) configured to grasp supporting gum and bone (152).

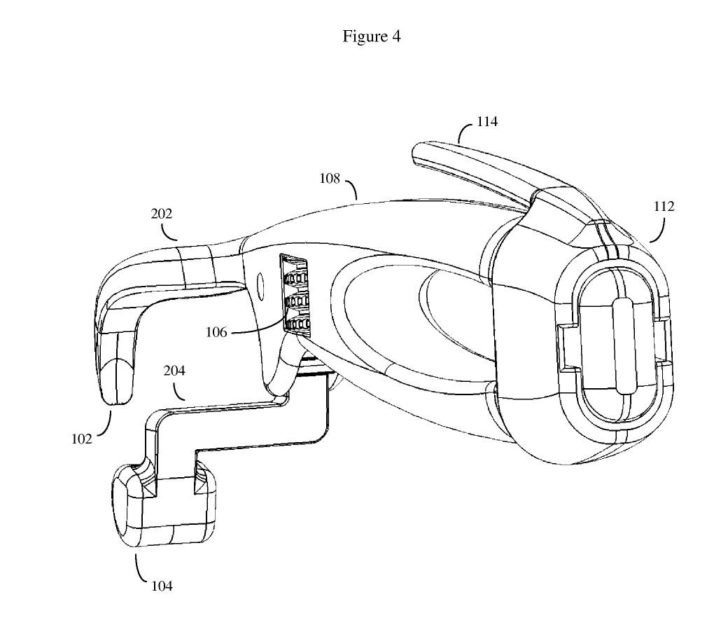

FIG. 4 shows a back view of the left handed version of the device, showing the back cap (112) and deformable lever (114) that may be used to determine the proper amount of force to apply to the device.

Here, for example, if excessive force is being applied by the dentist, the deformable lever (114) will deform so much as to touch the device's handle (108), thus giving the dentist feedback that excessive force is being used. To do this, the amount of deformable material in the junction between the deformable lever (114) and the back cap (112) can be selected, in combination with the known deformability characteristics of the lever and back cap material, and the known levels of excessive pressure where the risk of bone breakage becomes overly high, so as to cause the lever (114) to touch the back handle (108) at a predetermined and calibrated level of force.

The dog leg or bent jaw configuration (202), (204) that is designed to have the handle avoid the lip during function can be reconfigured in the mirror image of itself (502), (504) so that it is effective on the contra-lateral opposite side of the mouth.

FIG. 5 shows a back view of a right handed version of the device. Here the right handed dog leg for the upper fixed tapered jaw is shown as (502), and the right handed dog leg for the lower moveable jaw is shown as (504).

FIG. 6 shows a symmetrical version of the device.

From a psychological perspective, the device offers certain other benefits for the patient as well. Forceps tend to rather resemble medieval instruments of torture, whereas a wrench is a more common everyday device not associated with psychological distress. Thus a patient seeing the invention is more likely to consider it to be a type of wrench, and will likely suffer less psychological distress as a result.

As previously discussed, the device may generally be considered to be a modified crescent wrench comprising an ergonometric single handle shaped to fit comfortably inside the dentist's loosely clenched hand. The device will generally have one end terminating in a fixed tapered jaw (102), as well as a broader movable jaw (104) that is moveably coupled to the handle, for example on an axle or pivot point. This broader moveable jaw will be moved relative to the fixed jaw. Usually this will be done using a thumbscrew or worm gear arrangement, or other jaw movement interface. This thumbscrew or worm gear will often be mounted in a hole in the handle, and when turned it will often engage a gear attached to the moveable jaw and in turn cause the moveable jaw to move relative to the fixed jaw. Other types of jaw movement interfaces that may be used include slides, finger buttons, or even small electric motors or switches for such small electric motors.

This tooth extraction wrench device is generally comprised of a handle having one end that terminates in a fixed tapered jaw, often with a sharpened edge, as well as a broader untapered movable jaw with a contoured surface. This surface, preferably contoured to match the gum, is intended to press up against sensitive gingival tissue, and thus may be polished, or even covered with a somewhat deformable material (such as plastic) in order to minimize trauma to the gingival tissue during the extraction process.

The section of the device's handle that houses both the fixed and movable jaws may be angled to allow extraction of both upper maxillary teeth and lower mandibular teeth. This is in contrast to the jaws of a dental forceps, which conventionally are angled so that a dedicated forceps design is generally used for upper teeth, and a different dedicated forceps design is generally used for the lower teeth.

As previously discussed, the moveable jaw is coupled to the handle and moved relative to the fixed tapered jaw by way of a gear arrangement, such as a worm gear—thumbscrew gear system that may be mounted in a hole in the handle. This worm gear or thumbscrew may, for example, be turned by the dentist's thumb or fingers to move the broader movable jaw relative to the fixed tapered jaw. In order to stop the movable jaw in position, pressure can be employed to the thumbscrew through the dentist's thumb, or alternatively some sort of additional locking device such as a switch or slide may be employed.

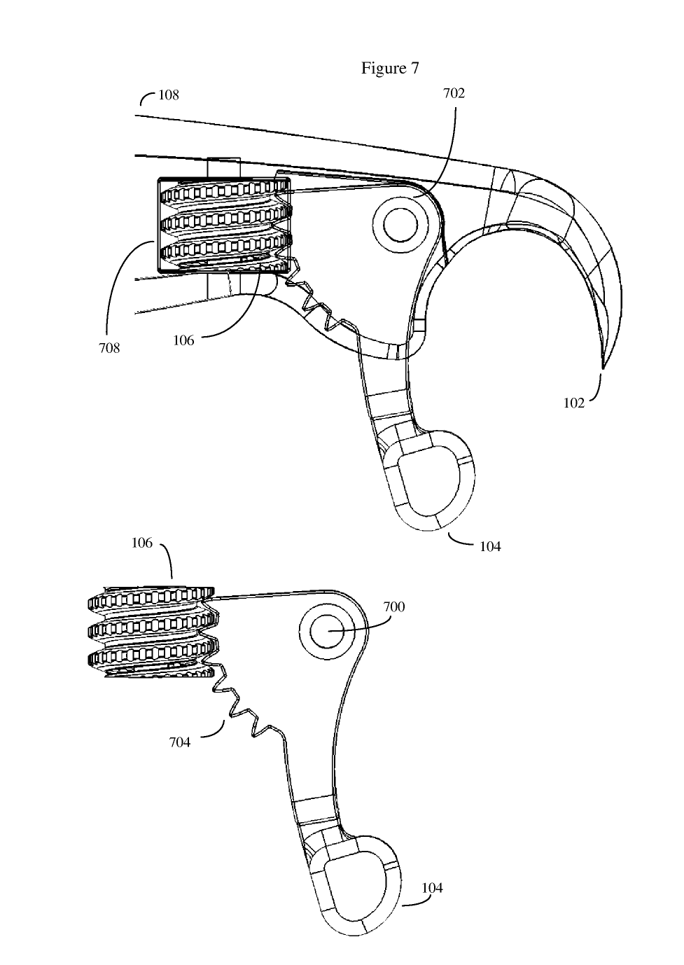

FIG. 7 shows a detail of the thumbscrew-worm gear arrangement which may be used to move the invention's moveable jaw. Here the handle (108) is made transparent so as to better show the workings of the thumbscrew—worm gear arrangement. As can be seen, often the moveable jaw (104) will have a built in pivot point or axle (700) designed to fit into a corresponding hole in the handle (702) as well as a built in gear arrangement (704). This in turn may interface with the worm gear (106). The worm gear in turn may be mounted on worm gear pivot point or axle (706), and the worm gear may fit into a hole in the handle (708).

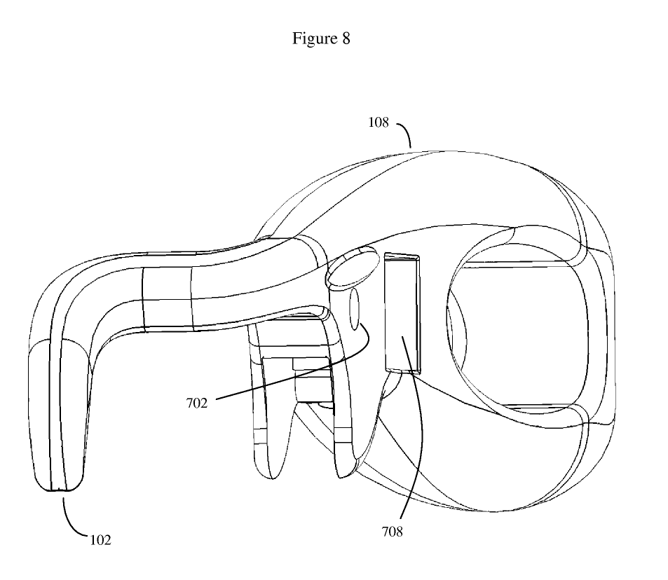

FIG. 8 shows a front view of the device handle showing the fixed tapered jaw (102) with a sharpened edge, as well as the hole in the handle for the pivot point (700) and the hole in the handle for the worm gear (708). Here the thumbscrew, the moveable jaw, and the optional back cap are not shown.

As previously discussed, the device may also comprise an optional here back cap (112) (like a cap on a pen) which functions as a force gauge. This gauge indicates (by sight or sound) when the user applies the limit of force that should be applied without causing major damage to the bone supporting the teeth. In a simpler embodiment, this force gauge may be a simple lever (114) made up of a deformable material with known deformability characteristics. Alternatively, more complex force sensor gauges, such as electronic gauges, may be used. Suitable materials for this force gage include various plastics, such as TC-852 A/B polyurethane and the like.

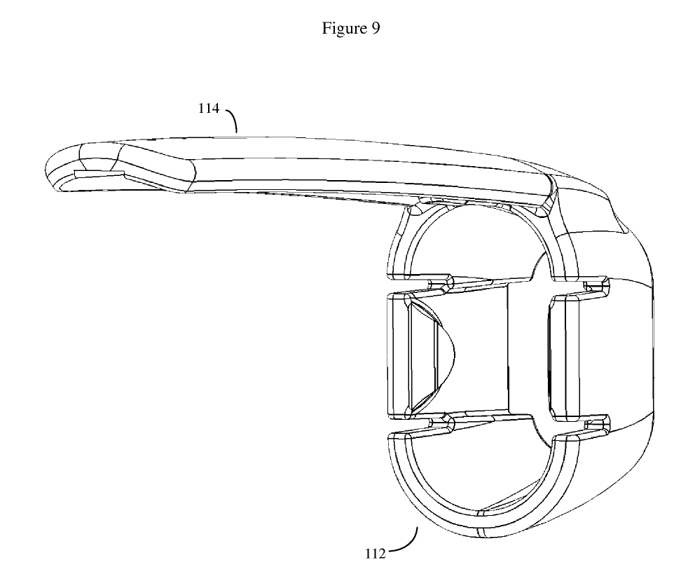

FIG. 9 shows a detail of the optional back cap (112) and deformable lever (114), which may be attached to the back of the device and used to assess the proper amount of force to apply.

As previously discussed, excessive unmeasured force of the outside of the tooth against the supporting buccal bone may break the bone. This is undesirable. In order to preserve the bone, a force gauge spring lever (114) may be added to the handle. When a fixed amount of force is applied to the force gauge spring lever, the lever will make contact with the handle. The exact amount of force required for the spring lever (114) to contact the handle is the ideal amount of force required to loosen the tooth without breaking the bone. The dentist may choose to remove the spring lever when the muscle memory can predictably duplicate this force without the spring.

FIG. 10 shows a side view of the device handle showing the fixed tapered jaw with a sharpened edge, but with the thumbscrew and moveable jaw reversed. The moveable jaw has a complex surface which forms a large center point of rotation or fulcrum for the lever created by the handle of the device, so that application of force to the handle causes a combined inwardly and upwardly actuated rotation of the handle, causing the tooth to pivot towards an inside lingual sided fulcrum and forcibly dislodge from the gum line and bone. In this configuration, the back cap and deformable lever also contain an electronic force sensor (1002). In this example, the electronic force sensor utilizes a more precisely calibrated force spring (1004) to sense pressure. The electronic force sensor also may incorporate a micro switch (1006) that lights up a light emitting diode (LED) (1008) (or alternatively makes a warning sound) when excess force is being applied. Thus, for example, when excessive force is being applied, the calibrated force spring (1004) will deform enough so that the micro switch (1006) contacts the device handle (108), which may in turn complete a simple battery operated electronic circuit (battery not shown) to light up the light emitting diode (108). Here the battery may, for example, be housed inside of the electronic force sensor (1002). Suitable batteries include button cell batteries and the like.

To summarize, the device can be produced in various versions, including a straight or symmetric (no dog leg) version (FIG. 6), which will generally be useful for pulling bicuspids, cupids, and incisors. The device may also be produced in a left handed dog leg version (FIGS. 2-4) for molars, or a right handed dog leg version (FIG. 5) for opposite molars. The device may also be produced in a reverse tilt straight version for teeth that are decayed on the tongue side (see FIG. 10). In a reverse tilt straight position, the angle of the handle (108) relative to the jaws (104), (102) is different. This angle can vary by any amount from 0 to 360 degrees, and in a reverse tilt version may be up to 180 degrees different. Other device versions may include a pediatric straight reduced sized version and a pediatric straight reverse tilt version.

The advantages of the device over prior art devices, such as the device of Golden, include less hand and fore arm fatigue due to the device's smaller, single handled ergonometric grip. This can reduce incidence of carpel tunnel syndrome in the dentist because the need for a tight hand grip and rotation is eliminated. The device will generally be much more comfortable to operate as well, because the dentist's hand can be relaxed throughout the procedure. The single handle is easier to grasp and easier for practitioners with smaller and weaker hands to operate. Further the force on the tooth can be made generally constant and appropriate throughout the procedure. Further, the thumbscrew fixed jaw arrangement allows for easy and optional selection of the direction of the force, depending upon the condition of the tooth. At the same time, the force calibration gauge on the back cap can help prevent use of excessive force during extraction, thus minimizing the risk of unwanted bone breakage.

The device may also be configured to be kinder to sensitive gingival tissue near the extracted tooth. The moveable jaw may be contoured to minimize buccal and gingival tissue trauma, as well as conform better to facial gingival tissue. The net result for patients is a gentler tooth extraction procedure with reduced pain, trauma, and quicker healing time, with less of a chance that fractured tooth roots will be left behind in the jaw.

1. A dental wrench device to loosen and extract teeth, comprising:
a handle shaped to fit substantially inside a hand;
one end of said handle terminating in a fixed tapered jaw configured to position along the tooth roots of a selected tooth below the gum line;
a moveable jaw coupled to said handle;
said moveable jaw having a contoured surface configured to grasp supporting gum and bone in which said tooth roots are embedded at a level below the crown of said selected tooth;
a jaw movement interface mounted in said handle, wherein operating said jaw movement interface moves said moveable jaw relative to said fixed tapered jaw; said device configured so that when said fixed tapered jaw is positioned along the surface of a selected tooth, and said moveable jaw is positioned with said contoured surface grasping said supporting gum and bone in which said tooth roots are embedded;
said device further configured so that application of force to said handle will cause said device to act as a fulcrum applying force to said tooth to dislodge said tooth from the supporting gum and bone in which the tooth roots of said tooth are embedded.

2. The device of claim 1, wherein when said fixed tapered jaw is positioned along the surface of a selected tooth, and said moveable jaw is positioned with said contoured surface grasping the supporting gum and bone in which said tooth roots are embedded, said moveable jaw may be locked into position.

3. The device of claim 1, further comprising a calibrated spring gage to determine the ideal force to loosen teeth without fracturing the bone in which the teeth are embedded.

4. The device of claim 1, wherein said jaw movement interface is a thumbscrew, worm gear, slide, finger button, or electric motor.

5. The device of claim 1, wherein the contoured surface of said moveable jaw further comprises a bumper contoured to engage the gingival tissue only proximate the tooth that is being extracted.

6. The device of claim 1, further comprising either
1: a back cap and a deformable lever made from a deformable material which deforms against said handle when excessive force is being used; or
2: a lever made from a rigid material attached to a back cap by way of a spring or spring loaded axle.

7. The device of claim 6, wherein said back cap and lever contain a force gauge.

8. The device of claim 1, wherein said jaws are configured with a dog leg bend in either or both of said fixed or adjustable jaws configured to prevent trauma to the lips of a patient when said device is positioned for the extraction of molar teeth.

9. The device of claim 8, in wherein said dog leg bend is configured in either a right handed or left handed configuration.

10. The device of claim 1, wherein said fixed tapered jaw has a sharpened, contoured edge.

11. A dental wrench device to loosen and extract teeth, comprising:
a handle shaped to fit substantially inside a hand;
one end of said handle terminating in a fixed tapered jaw with a sharpened edge configured to position along the tooth roots of a selected tooth below the gum line;
a moveable jaw coupled to said handle;
said moveable jaw having a contoured surface configured to grasp supporting gum and bone in which said tooth roots are embedded at a level below the crown of said selected tooth;
wherein said jaws are configured with a dog leg bend in either or both of said fixed or adjustable jaws configured to prevent trauma to the lips of a patient when said device is positioned for the extraction of molar teeth;
a jaw movement interface mounted in said handle, wherein operating said jaw movement interface moves said moveable jaw relative to said fixed tapered jaw;
wherein when said fixed tapered jaw is positioned along the surface of a selected tooth, and said moveable jaw is positioned with said contoured surface grasping said supporting gum and bone in which said tooth roots are embedded, said moveable jaw may be locked into position;
said device configured so that when said fixed tapered jaw is positioned along the surface of a selected tooth, and said moveable jaw is positioned with said contoured surface grasping said supporting gum and bone in which said tooth roots are embedded, then application of force to said handle will cause said device to act as a fulcrum applying force to said tooth to dislodge said tooth from the supporting gum and bone in which the tooth roots of said tooth are embedded;
further comprising a back cap and a deformable lever made from a deformable material which deforms against said handle when excessive force is being used.

12. The device of claim 11, further comprising a calibrated spring gage to determine the ideal force to loosen teeth without fracturing the bone in which the teeth are embedded.

13. The device of claim 11, wherein said jaw movement interface is a thumbscrew, worm gear, slide, finger button, or electric motor.

14. The device of claim 11, wherein the contoured surface of said moveable jaw further comprises a bumper contoured to engage the gingival tissue only proximate the tooth that is being extracted.

15. The device of claim 11, in wherein said dog leg bend is configured in either a right handed or left handed configuration.

16. A method to loosen and extract teeth, comprising;
applying a dental wrench device to a tooth to be extracted;
said device comprising a handle shaped to fit substantially inside a hand;
one end of said handle terminating in a fixed tapered jaw with a sharpened edge configured to position along the tooth roots of a selected tooth below the gum line;
a moveable jaw coupled to said handle;
said moveable jaw having a contoured surface configured to grasp supporting gum and bone in which said tooth roots are embedded at a level below the crown of said selected tooth;
a jaw movement interface mounted in said handle, wherein operating said jaw movement interface moves said moveable jaw relative to said fixed tapered jaw;
operating said jaw movement interface so as to position said fixed tapered jaw tightly along
the tooth surface of a selected tooth, and so as to position the contoured surface of said moveable jaw so as to tightly grasp said supporting gum and bone in which said tooth roots are embedded;
applying force to said handle in a direction to cause said device to act as a fulcrum which in turn applies force to said tooth to dislodge said tooth from the supporting gum and bone in which the tooth roots of said tooth are embedded;
and extracting said tooth.

17. The method of claim 16, wherein said device is removed from said tooth prior to extracting said tooth.

18. The method of claim 16, further using a force gauge to determine the proper amount of force to apply to said handle.

19. The method of claim 16, in which said fixed tapered jaw with a sharpened edge is positioned to abut against an inwardly facing side of a selected tooth, and said moveable jaw having a contoured surface is positioned to grab and align with the patient's gum below the gum line on the outwardly facing side of said selected tooth.

20. The method of claim 19, wherein the moveable jaw having a complex surface forms a large center point of rotation or fulcrum for the lever created by said handle of the device, so that application of force to said handle causes a combined outwardly and downwardly actuated rotation of the handle, causing said tooth to pivot towards the fulcrum and forcibly dislodge from the gum line and bone.

21. The method of claim 16, in which said fixed tapered jaw with a sharpened edge is positioned to abut against an outwardly facing side of a selected tooth, and said moveable jaw having a contoured surface is positioned to grab and align with the patient's gum below the gum line on the inwardly facing side of said selected tooth;
wherein the moveable jaw having a contoured surface forms a large center point of rotation or fulcrum for the lever created by said handle of the device, so that application of force to said handle causes a combined inwardly and upwardly actuated rotation of the handle, causing said tooth to pivot towards the fulcrum and forcibly dislodge from the gum line and bone.
